(19) United States
(12) Patent Application Publication
(10) Pub. No.: US 2005/0262015 A1
(43) Pub. Date: Nov. 24, 2005

(54) Systems and methods for hedging against risks associated with distressed instruments

(75) Inventors: Michael Kownacki, Mahwah, NJ (US); Constantine Skondras, Wyckoff, NJ (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: Cantor Fitzgerald & Co.

(21) Appl. No.: 10/925,416

(22) Filed: Aug. 24, 2004

Related U.S. Application Data
(60) Provisional application No. 60/498,392, filed on Aug. 27, 2003.
(60) Provisional application No. 60/501,538, filed on Sep. 8, 2003.

(51) Int. Cl. G06F 17/60

(52) U.S. Cl. 705/38

(57) ABSTRACT

Systems and methods for hedging against risks associated with distressed instruments are provided. These systems and methods are preferably directed towards providing a party wishing to protect itself from such risks with the opportunity to enter into a transaction with a provider of protection whereby such a party pays a risk protection premium to the provider of protection in exchange for the right to receive payment in the event that the value of the distressed instrument on or about maturity is below an agreed to strike price.

### CROSS REFERENCE TO RELATED APPLICATIONS

This application claims priority from U.S. Provisional Patent Applications Nos. 60/498,392, filed Aug. 27, 2003, and 60/501,538, filed Sep. 8, 2003.

### BACKGROUND OF THE INVENTION

This invention relates to systems and methods for hedging against risks associated with distressed instruments. More particularly, this invention relates to creating and processing transactions that are designed for the efficient hedging of various levels of financial risk(s) impacting, related to, associated with, as a result of and in consideration of, the granting of, acceptance of, and/or extension of, financial obligations pursuant to a contractual agreement, the performance of which, due to various economic, business, financial and/or credit related factors, is perceived, feared and/or deemed in jeopardy, highly unlikely, believed to be challenged and/or has already failed.

Distressed instruments generally include performing and non-performing, public and private, commercial and non-commercial, rated and non-rated, secured and unsecured financial obligations which are currently in a distressed state, where default is generally feared to be imminent or in which an event of default has already occurred pursuant to the financial obligation and its contractual requirements. Over the last few years, the global market for such instruments has grown to unprecedented record levels as the number of entities defaulting on their obligations has increased. With a slowly recovering economy, global uncertainty about war and terrorism, and poor credit quality, default rates are likely to remain at relatively high levels in comparison to historical data.

As distressed instruments pile up at record levels on the balance sheets and books of financial institutions around the world, these institutions look for new and more efficient ways to reduce the high costs associated with such instruments. In a drastic measure to reduce the costly burden of distressed instruments, financial institutions have sought to eliminate them from their books. For example, these institutions have reluctantly, but swiftly, resorted to “dumping” large blocks of distressed instruments to so called vulture buyers at price levels far below their ultimate recovery values, otherwise known as final market values. As huge volumes of distressed instruments flood the financial markets, fair market value trading prices for distressed instruments have become depressed in response to increased supply meeting a generally illiquid market. These depressed prices are not necessarily good indicators of longer-term recovery levels for the distressed instruments as fair market value trading prices often vary significantly from final market values. In estimating ultimate loss, final market values are more accurate indicators than market value trading prices. Research indicates that debt cushion—i.e., the percentage of inferior financial obligations in the capital structure—and the degree and quality of collateral securing the distressed instruments are key predictors of final market values. Furthermore, position on the balance sheet with respect to the distressed instruments is another important feature in predicting final market values.

While traditional methods provide for hedging against risks associated with many financial instruments (credit, interest rate, and/or currency exposure), including distressed instruments, such methods are extremely difficult to effect. This is due to counterparties' reluctance to bear the high risks associated with the high level of probability that an instrument experiencing a state of distress will ultimately default. Consequently, such methods, if available, are so costly they render the hedge prohibitive, depending upon the state of distress. For example, hedging distressed debt risk using credit derivatives may require payment of very high premiums in return for the right to sell the distressed debt for a specified price on a specified date.

There is therefore an increasing need for new and more efficient systems and methods which provide for hedging against risks associated with distressed instruments.

### SUMMARY OF THE INVENTION

It is therefore an object of the invention to provide systems and methods for the efficient hedging against risks associated with distressed instruments.

This and other objects are accomplished in accordance with the principles of the invention by providing systems and methods that enable transactions for hedging against risks associated with distressed instruments. More specifically, these transactions are entered into by at least one purchaser of protection seeking to hedge the risks associated with a distressed instrument and at least one provider of protection. As part of a proposed transaction that is entered into on an effective date in connection with a particular distressed instrument having a maturity date, and/or a portfolio of distressed instruments, the purchaser of protection pays a risk protection premium to the provider of protection in exchange for the right to receive a payment in the event that the final market value—i.e., the value of the distressed instrument on or about the maturity date—is below a strike price. The final market value of the distressed instrument is determined at least based on the value of assets pledged to secure the distressed instrument. The strike price may be determined based on the level of risk undertaken by the provider of protection and/or the level of risk protection required by the purchaser of protection. Preferably, the strike price is determined at least based on the value of the distressed instrument as of the effective date.

### BRIEF DESCRIPTION OF THE DRAWINGS

Further features of the invention, its nature and various advantages will be more apparent from the following detailed description of the preferred embodiments, taken in conjunction with the accompanying drawings, in which like reference characters refer to like parts throughout, and in which:

FIG. 1 is a block diagram of a system that may be used to implement the processes and functions of certain embodiments of the invention;

FIG. 2 is a block diagram of a workstation, a server and a back office clearing center that may be used to implement the processes and functions of certain embodiments of the invention;

FIG. 3 is a diagram illustrating a proposed transaction between a party purchasing protection and a counterparty providing protection in accordance with certain embodiments of the invention; and

FIG. 4 is a flow diagram of a process that may be used to establish a proposed transaction in accordance with certain embodiments of the invention.

### DETAILED DESCRIPTION OF THE INVENTION

This invention relates to systems and methods for providing transactions for hedging against risks associated with a distressed instrument or a portfolio of distressed instruments.

A transaction preferably is arranged between a purchaser of protection—e.g., a depository institution, an insurance institution, a speculator or other individual, etc.—and a provider of protection—e.g., a depository institution, and insurance institution, a speculator or other individual, etc.

Under the proposed transaction, the purchaser of protection may pay a risk premium to the provider of protection in return for the right to receive payment in the event that the market value of the instrument on or about the maturity date of the distressed instrument is below a specified amount, otherwise know as the strike price. Accordingly, the proposed transaction provides an opportunity for financial institutions and the like to purchase risk protection that enables them to continue to hold distressed instruments that they might otherwise sell at considerably lower values. Because such institutions are protected from some degree of loss on the distressed instruments up to the amount of the strike price, they are able to hedge and diversify the risks associated with such instruments. Moreover, by substituting the credit risks of such instruments with those of preferably highly rated counterparties, such institutions may be provided with an efficient solution to the high cost of carrying, for example, well-structured albeit distressed debt on their balance sheets. Furthermore, institutions that participates in the proposed transaction may lower the risk-weighting applicable to the distressed instrument, as will be discussed further below. The above-mentioned considerations render the proposed transaction more appealing and efficient than available alternatives such as hedging using credit derivatives.

Some instruments are backed by very good collateral, such as cash, current assets, real estate, property, plant and equipment, while others may be backed by less attractive collateral, such as second liens or capital stock of subsidiaries. The final market values improved similarly for instruments that were collateralized, as compared to ones that were not. Collateral by itself is significant. The ultimate recovery risk is highly correlated with the intrinsic value of the underlying collateral. Furthermore, research indicates that the subset of distressed instruments that do default on their obligations stay in bankruptcy for a relatively short period of time. For example, the average time in bankruptcy for rated corporations is approximately one and a half years with the exception of that of the utility subset, which is more than twice that, at 36 months. This subset of distressed instruments lingers in default and/or bankruptcy for significantly longer periods of time than general corporations because of their extended negotiations with federal regulatory bodies. It is likely that financial institutions are more patient with distressed utility companies because of the intrinsic value of the industry, due to the inelasticity of demand and their monopoly franchises. Surprisingly, an analysis of this subset of the distressed instruments reveals that, despite the extended time in default/bankruptcy, they still recover nearly 100% of principal and interest. Clearly, financial institutions that enter and extend these financial obligations will now have highly efficient means, through the proposed transactions described herein, to continue on with their relationships should obligors experience some degree of financial difficulty instead of dumping distressed instruments at ‘bargain basement’ prices.

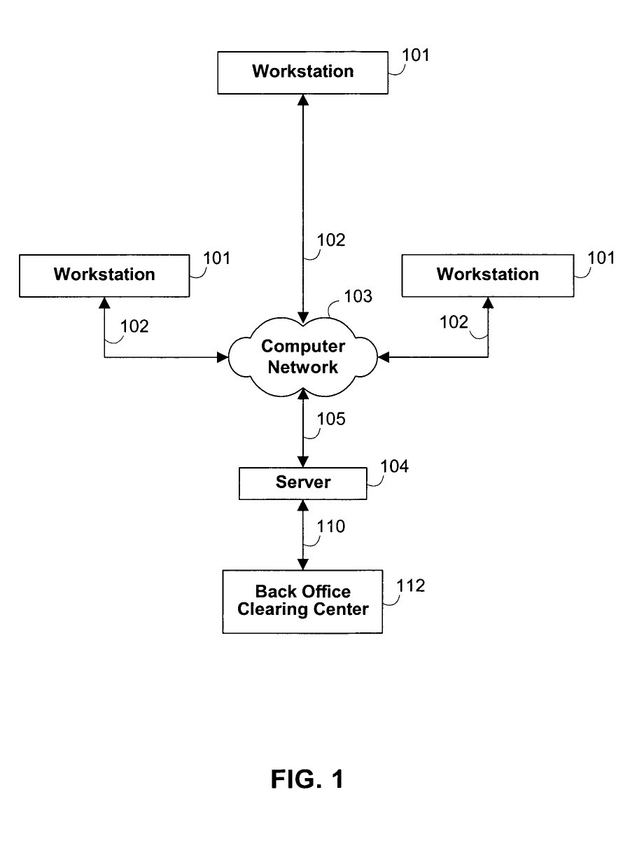

Further details of the invention are described below with respect to FIGS. 1-4.

Referring to FIG. 1, exemplary system 100 for implementing the invention is shown. System 100 may be used to enter into the proposed transaction described herein, analyze and structure them or transfer or trade distressed instruments. As illustrated, system 100 may include one or more workstations 101. Workstations 101 may be local or remote, and are connected by one or more communications links 102 to computer network 103 that is linked via communications links 105 to server 104. Server 104 is linked via communications link 110 to back office clearing center 112.

In system 100, server 104 may be any suitable server, processor, computer, or data processing device, or combination of the same. Server 104 may be used to process the transactions entered into by one or more purchasing parties and counterparties.

Computer network 103 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 102 and 105 may be any communications links suitable for communicating data between workstations 101 and server 104, such as network links, dial-up links, wireless links, hard-wired links, etc.

Workstations 101 may be personal computers, laptop computers, mainframe computers, dumb terminals, data displays, Internet browsers, Personal Digital Assistants (PDAs), two-way pagers, wireless terminals, portable telephones, etc., or any combination of the same. Workstations 102 may be used by the purchaser of protection, or a representative thereof, and/or the provider of protection, or a representative thereof, in order to enter into and proceed with the proposed transaction according to the invention. For example, any one of workstations 102 may be adapted to receive a command to enter into the proposed transaction by paying a risk protection premium to the provider of protection. Similarly, any one of workstations 102 may be adapted to display the risk protection premium payable to the provider of protection. Workstations 102 may also be used by any other party to enter commands including, for example, bids and offers, to trade the distressed instrument.

Back office clearing center 112 may be any suitable equipment, such as a computer, a laptop computer, a mainframe computer, etc., or any combination of the same, for causing the proposed transaction, and other transactions such as transactions involving the trading of distressed instruments, to be cleared and/or verifying that transactions are cleared. Communications link 110 may be any communications links suitable for communicating data between server 104 and back office clearing center 112, such as network links, dial-up links, wireless links, hard-wired links, etc.

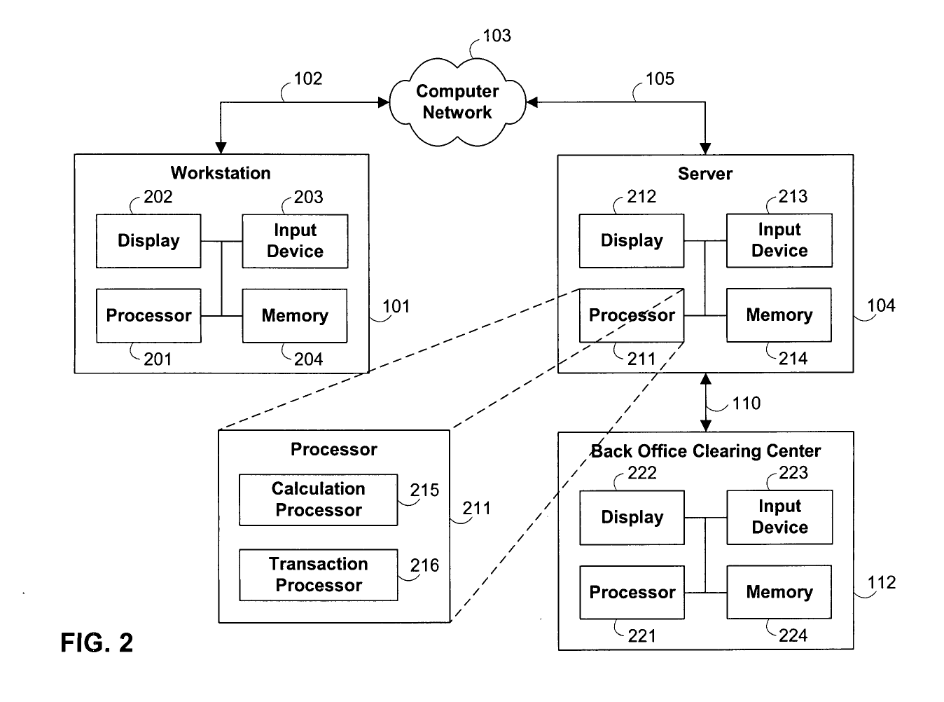

The server, the back office clearing center, and one of the workstations, which are depicted in FIG. 1, are illustrated in more detail in FIG. 2. Referring to FIG. 2, workstation 101 may include processor 201, display 202, input device 203, and memory 204, which may be interconnected. In a preferred embodiment, memory 204 contains a storage device for storing a workstation program for controlling processor 201. Processor 201 uses the workstation program to present on display 202 information relating to the proposed transaction to a user of workstation 101. Such information may include the risk protection premium payable by the purchaser of protection, an offer to enter into the proposed transaction, the effective date of the proposed transaction, the terms of the proposed transaction agreement, the maturity date of the proposed transaction, the strike price, as well as information relating to the associated distressed instrument, such as its maturity date, its associated market risk, its fair market value, final market value, prevailing secondary market trading value, average bid prices, etc. Furthermore, input device 203 may be used to enter such information and to enter into the proposed transaction or trade the distressed instrument through, for example, entering a command that may be received by processor 201 and communicated to server 104.

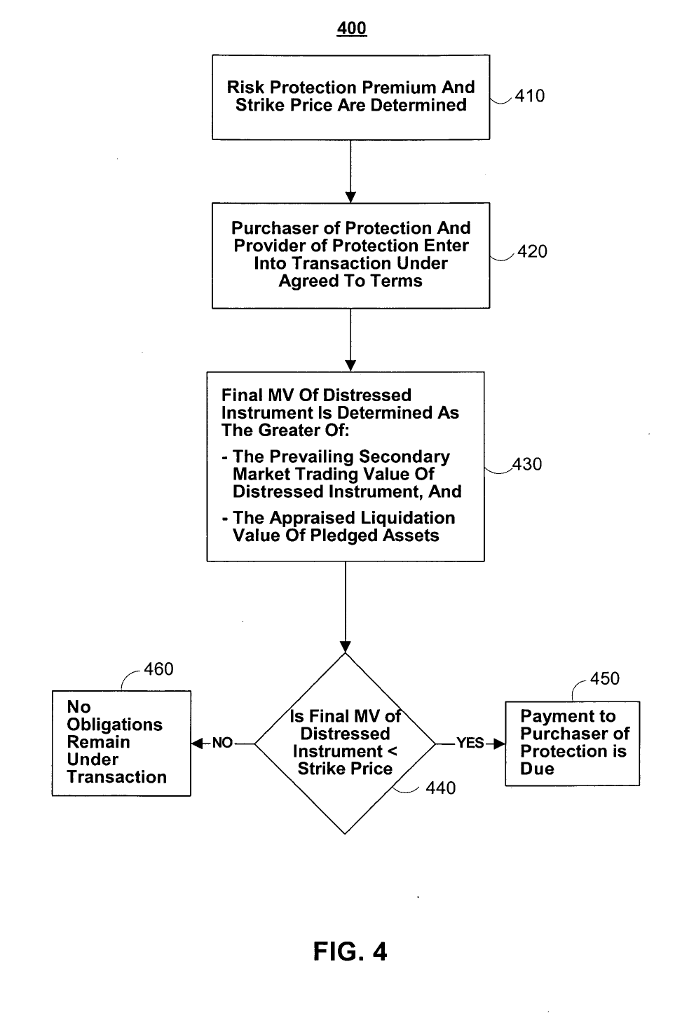

Server 104 may include processor 211, display 212, input device 213, and memory 214, which may be interconnected. In a preferred embodiment, memory 214 contains a storage device for storing the information relating to the transactions entered into by one or more purchasing parties and counterparties. The storage device further contains a server program for controlling processor 211. Processor 211 may use the server program to process the transaction information and commands displayed to and received from the purchaser of protection and the provider of protection. Processor 211 may use the server program to process the proposed transaction. Processor 211 may include calculation processor 215 that determines, for example, the strike price and the final market value of the distressed instrument based on, for example, the fair market value of the distressed instrument, the prevailing secondary market trading value of the distressed instrument and the appraised liquidation value of the pledged assets, as discussed in connection with FIG. 4. Processor 211 may include transaction processor 216 that processes the transaction entered into by the purchaser of protection and the provider of protection. Transaction processor 216 may also process transactions involving the trading of the distressed instruments, thereby supporting the secondary market trading of the instruments. Processor 216 may, for example, match potential buyers and sellers by matching their credit risks or the bid/offer prices they have entered.

Back office clearing center 112 may include processor 221, display 222, input device 223, and memory 224, which may be interconnected. In a preferred embodiment, memory 224 contains a storage device for storing a clearing program for controlling processor 221. Processor 221 uses the clearing program to complete the transactions that are entered into by the purchaser of protection and the provider of protection, as well as the trades of various distressed instruments, and to clear these transactions and trades. Processor 221 uses the clearing program to further verify that the transactions and trades are completed and cleared.

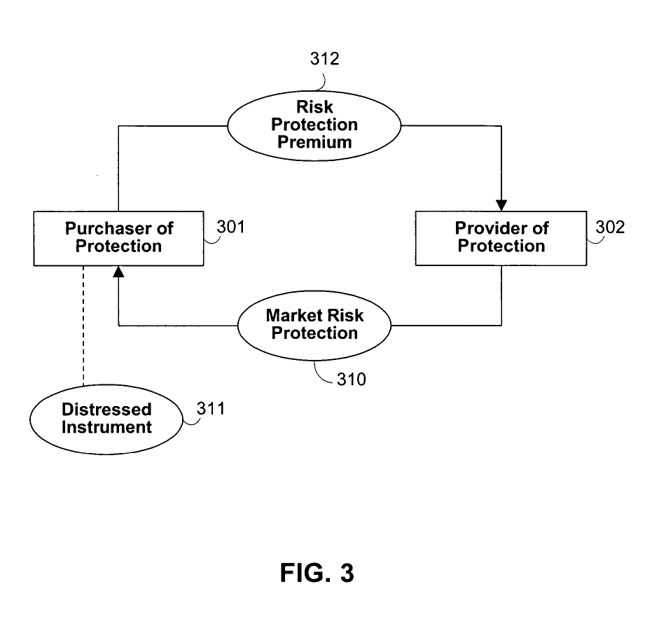

FIG. 3 depicts a proposed transaction involved between purchaser of protection 301 and provider of protection 302. Purchaser of protection 301 and provider of protection may be a U.S. or foreign institution such as a bank or an insurance institution, or an individual such as a speculator. Preferably, purchaser of protection 301 may be a U.S. or foreign bank. Provider of protection 302 may also be a U.S. or foreign institution or individual. Preferably, provider of protection 302 may be a bank incorporated in the U.S. or in a country that is a member of the Organization for Economic Cooperation and Development (“OECD”).

Both parties 301 and 302 preferably enter into the transaction on a reference date known as the effective date. As part of the transaction, purchaser of protection 301 may pay risk protection premium 312 to provider of protection 302 in return for market risk protection 310 against distressed instrument 311. Distressed instrument 311 may be any performing or non-performing, public or private, commercial or non-commercial, rated or non-rated, senior or non-senior, secured or unsecured financial obligation. Preferably, distressed instrument 311 may be secured debt in distressed state—i.e., where default has occurred or is generally feared to be imminent. Additionally, distressed instrument 311 may also be senior debt. Accordingly, distressed instrument 311 preferably possesses value as a result of its seniority within the obligor's capital structure and/or is secured by asset(s) pledged as collateral to the debt.

Risk protection premium 312 may be payable to provider of protection 302 in return for market risk protection 310, which includes a granted right to receive payment in the event that the market value of the instrument at maturity is below an agreed to strike price.

Risk protection premium 312 may be payable to provider of protection 302 in one lump sum for the entire term of the proposed transaction. Risk protection premium 312 may payable on the effective date—i.e., the date the proposed transaction is entered into—or at any other time. Alternatively, risk protection premium 312 may be divided into equal payments that are periodically payable—e.g., at the beginning of each month, quarter or year—to provider of protection 302 during the term of the proposed transaction. The amount of risk protection premium 312 may be determined using a Black-Scholes option pricing analysis. Such an analysis may be based on the sum of the credit risk associated with purchaser of protection 301 and an additional risk premium. The sum of the credit risk associated with purchaser of protection 301 may be determined by its prevailing credit market spread above the risk-free rate of return—i.e., that of U.S. Treasury bills, notes or bonds—on a 360-day basis. The additional risk premium may be determined based on the pledged assets (including excess collateral, if any).

FIG. 4 shows flow chart 400 illustrating a proposed method according to the invention. At step 410, the risk protection premium may be determined as discussed above. Additionally, the strike price may be determined at step 410. The strike price may be agreed to by the parties on or prior to the effective date—i.e., the date the proposed transaction is entered into—and may be determined based on any method chosen by such parties. The provider of protection may agree to a strike price based on the level of risk it is willing to undertake. The strike price may therefore be determined by the provider of protection. Alternatively, the strike price may be determined by the purchaser of protection based on the level of risk protection it requires. The strike price may alternatively be determined based on the level of risk undertaken by the provider of protection and the level of risk protection required by the purchaser of protection. Alternatively, the strike price may be determined by a suitable third party. Preferably, the strike price may be based on the approximate fair market value of the distressed instrument as of the effective date. The approximate fair market value may be calculated, estimated or appraised using any suitable method.

At step 420, the purchaser of protection and the provider of protection may enter into the proposed transaction in accordance with specific terms agreed to by both parties on the effective date. Such terms preferably may be governed by specific modifications and amendments to the International Swaps and Derivatives Association, Inc. (“ISDA”) Master Agreement and related schedules and confirmations thereto.

The final market value of the distressed instrument—i.e., the market value of the instrument on or about the maturity date of the proposed transaction—may be determined at step 430. The maturity date of the proposed transaction preferably corresponds to the maturity date of the distressed instrument. The final market value may be the greater of (i) the prevailing secondary market trading value of the distressed instrument, and (ii) the appraised liquidation value of all assets pledged as collateral to secure the distressed instrument under the indenture or corporate lending agreements. The final market value preferably may be determined by a calculation agent selected by the purchaser of protection and the provider of protection. The final market value may be determined on or after the maturity date of the proposed transaction. For example, the final market value may be determined within 10, 15, 30 or 45 days after the maturity date of the proposed transaction.

The prevailing secondary market trading value preferably may be determined through a bid/offer process. The prevailing secondary market trading value preferably may be based on the arithmetic average of bid prices entered by a minimum number of dealers or traders within a specified period of time after the maturity date of the proposed transaction. For example, the prevailing secondary market trading value may be based on the arithmetic average of the bid prices provided by 2 or 3 traders within 10, 15, 30 or 45 days after the maturity date of the proposed transaction. The prevailing secondary market trading value preferably may be determined by the calculation agent or any other suitable third party. Alternatively, the prevailing secondary market trading value may be determined by any other suitable method. The final market value of the distressed instrument may be set as the prevailing secondary market trading value of the distressed instrument.

The liquidation value of the pledged asset(s) may be determined through an appraisal process. The appraisal of the liquidation value of the pledged asset(s) may be performed by an appropriate entity. For example, the appraisal may be performed by an accounting firm agreed to by the purchaser of protection and the provider of protection, the calculation agent, the purchaser of protection or the provider of protection. The liquidation value of the pledged asset(s) may be the ultimate recovery value of, or the estimated amount recovered from the sale of, the pledged asset(s) on or about the maturity date of the proposed transaction. The liquidation value of the pledged asset(s) may alternatively be determined by any other suitable method. The final market value of the distressed instrument may be set as the appraised liquidation value of pledged assets.

In an alternative embodiment of the invention, the final market value may be determined on or about the maturity date of the proposed transaction through the sale of the pledged asset(s). Alternatively, the final market value may be determined by any other suitable method.

Because the maturity date of the proposed transaction preferably corresponds to the maturity date of the distressed instrument, the term of the proposed transaction—i.e., the term remaining until the maturity date of the proposed transaction—preferably matches the term remaining until the maturity date of the distressed instrument. Restrictions or options that are associated with the distressed instrument may also apply to the proposed transaction. Such restrictions or options can include call options that are part of the terms of the distressed instrument. For example, if the distressed instrument matures in two years but, under certain conditions, can be called within one year, the maturity date of the proposed transaction will also be in two years, with an optional call after one year.

In a preferred embodiment of the invention, the proposed transaction may be terminated prior to the maturity date of the distressed instrument by either party in the event of a credit event of default with respect to the other party. A credit event of default may occur upon (i) a cross default, receivership or restructuring with respect to either the purchaser of protection or the provider of protection or the assignment by a nationally recognized rating agency of a rating below investment grade with respect to the purchaser of protection or the provider of protection for obligations maturing on or about the maturity date of the proposed transaction, or (ii) the failure by the purchaser of protection to make a scheduled risk protection premium payment. Nevertheless, the purchaser of protection may be given a grace period—e.g., 15 business days—to make a scheduled risk protection premium payment. The termination date with respect to a credit event of default may be the tenth business day, or any other suitable period, following the provision of notice of the credit event of default to the defaulting party by the non-defaulting party.

Alternatively, the proposed transaction may be terminated prior to the maturity date of the distressed instrument through a voluntary termination by either the provider of protection or the purchaser of protection under certain conditions. For example, under a voluntary termination, the purchaser of protection may terminate the proposed transaction on each successive 360-day period, or any other suitable period, from the effective date of the proposed transaction upon notice—e.g., 60 days' prior written notice—to the provider of protection. The termination date with respect to a voluntary termination by the purchaser of protection may be the anniversary of the effective date immediately following the notice of termination. As an another example, the proposed transaction may be voluntarily terminated by the provider of protection as of the one-year anniversary of the effective date.

Alternatively, the proposed transaction may be terminated using any other suitable method at any suitable time.

If the proposed transaction is terminated prior to the maturity date of the distressed instrument, the purchaser of protection's obligation to make further risk protection premium payments may cease, subject to the purchaser of protection's obligation to make risk protection premium payments which became due prior to the termination date but which have not yet been paid.

At step 440, a determination of whether a market value event has occurred is made. A market value event occurs when the final market value of the distressed instrument is less than the strike price on or about the maturity date of the proposed transaction. If a market value event has occurred, the provider of protection may be notified of its obligation to make a payment to the purchaser of protection pursuant to the proposed transaction agreement. In a preferred embodiment of the invention, the calculation agent may deliver a notice of the provider of protection's obligation to the provider of protection.

At step 450, the provider of protection may make such payment to the purchaser of protection within a specified period time of the maturity of the proposed transaction if it is determined at step 440 that the final market value of the distressed instrument is less than the strike price. For example, the provider of protection must pay the purchaser of protection within 1, 5 or 10 business days after receipt of notice from the calculation agent. The payment preferably may be a cash settlement in an amount substantially equal to the difference between the final market value and the strike price, as determined in step 430. Alternatively, payment may be a physical settlement whereby the purchaser of protection delivers the distressed instrument to the provider of protection who pays the purchaser protection an amount substantially equal to the strike price. Alternatively, payment may be through a partial cash settlement, or any other suitable method. The type of payment may be agreed to in advance, selected by the purchaser of protection in advance, selected by the provider of protection in advance, selected by the purchaser of protection on or about the maturity date of the proposed transaction, agreed to on or about the maturity date of the proposed transaction, or selected by the provider of protection on or about the maturity date of the proposed transaction.

If it is determined at step 440 that the final market value of the distressed instrument is not less than the strike price, no payment will be required at step 460, and neither the purchaser of protection nor the provider of protection may have any further obligations under the proposed transaction.

Notwithstanding the foregoing, the provider of protection may not be required to make any payment to the purchaser of protection in the event of a voluntary termination by the purchaser of protection or a termination of the proposed transaction by the provider of protection as a result of a credit event of default with respect to the purchaser of protection. In the event of a termination of the proposed transaction by the purchaser of protection as a result of a credit event of default with respect to the provider of protection, the provider of protection preferably will be obligated to make a payment to the purchaser of protection if, as of the termination date, the final market value of the distressed instrument is less than the strike price. On the other hand, voluntary termination by the provider of protection may be subject to the provider of protection's obligation to make a payment to the purchaser of protection if the final market value as of the termination date is lower than the strike price.

As mentioned above, the distressed instrument may be a commercial debt or loan obligation. Commercial debt or loan obligations are typically assigned a 100% risk-weighting, unless the identity of the obligor under the indenture or corporate lending agreements would qualify the instruments for a lower risk-weighting. The proposed transaction may enable the purchaser of protection to lower the risk-weighting applicable to the distressed instrument. That is because long-term claims on, as well as portions of long-term claims that are guaranteed by, U.S. depository institutions and OECD banks, generally qualify for a 20% risk-weighting. As a result of the proposed transaction, the credit risk with respect to a portion of the distressed instrument may be transferred to the provider of protection, which preferably is an OECD depository institution, according to the invention. Accordingly, the bank may apply as low as 20% risk-weighting to that portion of the instrument that is subject to the credit protection provided by the provider of protection under the proposed transaction.

The present invention may also apply to other instruments such as mortgages and mortgage-backed securities, bills, bonds, notes, certificates of deposit, guaranteed investment contracts, commercial paper, banker's acceptance and the like.

One of ordinary skill in the art should appreciate that the invention may be practiced in embodiments other than those illustrated herein without departing from the spirit and scope of the invention. For example, speculators wishing to profit from fluctuations in the value of a distressed instrument may estimate the final market value of the distressed instrument using an approach similar to step 430 of FIG. 4 and may buy or sell call or put options having strike prices that are based on the estimated final market value. More specifically, a speculator may estimate the value of the distressed instrument based on the appraised liquidation value of the assets pledged to secure the distressed instrument and, optionally, the prevailing secondary market trading value of the distressed instrument. If, for example, the speculator estimates the final market value of the distressed instrument to be lower than expected, the speculator may buy an option to sell—i.e., a put option on—the distressed instrument for a strike price that substantially corresponds to the estimated final market value of the distressed instrument. On other hand, if, for example, the speculator estimates the final market value of the distressed instrument to be higher than expected, the speculator may buy an option to buy—i.e., a call option on—the distressed instrument for a strike price that substantially corresponds to the estimated final market value of the distressed instrument.

It will be understood that the foregoing is only illustrative of the principles of the invention, and that various modifications can be made by those skilled in the art without departing from the scope and spirit of the invention, and the present invention is limited only by the claims that follow.

1. A method for hedging against risk associated with a distressed instrument having a maturity date through a transaction entered into with a purchaser of protection on an effective date, the method comprising:
receiving a risk protection premium from the purchaser of protection; and
granting a right to receive payment in the event that the value of the distressed instrument on or about the maturity date is below a strike price, the value of the distressed instrument on or about the maturity date being at least based on the value of assets pledged to secure the distressed instrument, the strike price being at least based on the value of the distressed instrument as of the effective date.

2. The method of claim 1 wherein the right to receive the payment comprises a right to receive an amount substantially equal to the difference between the strike price and the value of the distressed instrument on or about the maturity date.

3. The method of claim 1 wherein the right to receive the payment comprises a right to receive an amount substantially equal to the strike price in return for delivering the distressed instrument.

4. The method of claim 1 wherein the value of the distressed instrument on or about the maturity date is the greater of (i) a secondary market trading value of the distressed instrument, and (ii) the value of the assets pledged to secure the distressed instrument.

5. The method of claim 4 wherein the secondary market trading value is determined based on an arithmetic average of bid prices relating to the distressed instrument, the bid prices being provided within a specified period of time after the maturity date.

6. The method of claim 1 wherein the value of the assets pledged to secure the distressed instrument is determined through an appraisal process.

7. The method of claim 1 the value of the assets pledged to secure the distressed instrument is an amount recovered from selling the assets.

8. The method of claim 1 wherein the value of the distressed instrument on or about the maturity date is determined through a sale of the assets pledged to secure the distressed instrument.

9. The method of claim 1 wherein the value of the distressed instrument on or about the maturity date is determined within a specified period of time after the maturity date.

10. The method of claim 1 wherein the risk protection premium is determined based on the sum of (i) a credit risk associated with the purchaser of protection, and (ii) an additional risk premium based on the assets pledged to secure the distressed instrument.

11. The method of claim 1 wherein the transaction may be terminated prior to the maturity date in the event of a credit event of default.

12. The method of claim 1 wherein the transaction may be terminated voluntarily prior to the maturity date.

13. A method for hedging against risk associated with a distressed instrument having a maturity date through a transaction entered into with a provider of protection on an effective date, the method comprising:
paying a risk protection premium from the purchaser of protection; and
receiving a right to receive payment in the event that the value of the distressed instrument on or about the maturity date is below a strike price, the value of the distressed instrument on or about the maturity date being at least based on the value of assets pledged to secure the distressed instrument, the strike price being at least based on the value of the distressed instrument as of the effective date.

14. The method of claim 13 wherein the right to receive the payment comprises a right to receive an amount substantially equal to the difference between the strike price and the value of the distressed instrument on or about the maturity date.

15. The method of claim 13 wherein the right to receive the payment comprises a right to receive an amount substantially equal to the strike price in return for delivering the distressed instrument.

16. The method of claim 13 wherein the value of the distressed instrument on or about the maturity date is the greater of (i) a secondary market trading value of the distressed instrument, and (ii) the value of the assets pledged to secure the distressed instrument.

17. The method of claim 16 wherein the secondary market trading value is determined based on an arithmetic average of bid prices relating to the distressed instrument, the bid prices being provided within a specified period of time after the maturity date.

18. The method of claim 13 wherein the value of the assets pledged to secure the distressed instrument is determined through an appraisal process.

19. The method of claim 13 wherein the value of the assets pledged to secure the distressed instrument is an amount recovered from selling the assets.

20. The method of claim 13 wherein the value of the distressed instrument on or about the maturity date is determined through a sale of the assets pledged to secure the distressed instrument.

21. The method of claim 13 wherein the value of the distressed instrument on or about the maturity date is determined within a specified period of time after the maturity date.

22. The method of claim 13 wherein the risk protection premium is determined based on the sum of (i) a credit risk associated with the party paying the risk protection premium, and (ii) an additional risk premium based on the assets pledged to secure the distressed instrument.

23. The method of claim 13 wherein the transaction may be terminated prior to the maturity date in the event of a credit event of default.

24. The method of claim 13 wherein the transaction may be terminated voluntarily prior to the maturity date.

25. A method for speculating about the risk associated with a distressed instrument having a maturity date, the method comprising:
estimating the value of the distressed instrument on or about the maturity date at least based on the value of assets pledged to secure the distressed instrument; and
buying or selling an option having a strike price that is based on the estimated value of the distressed instrument on or about the maturity date.

26. The method of claim 25 wherein the estimated value of the distressed instrument on or about the maturity date is the greater of (i) a secondary market trading value of the distressed instrument, and (ii) the value of the assets pledged to secure the distressed instrument.

27. The method of claim 26 wherein the secondary market trading value is determined based on an arithmetic average of bid prices relating to the distressed instrument.

28. The method of claim 25 wherein the value of the assets pledged to secure the distressed instrument is determined through an appraisal process.

29. A system for hedging against risk associated with a distressed instrument having a maturity date through a transaction entered into by a purchaser of protection and a provider of protection on an effective date, the system comprising:
a plurality of workstations that electronically display information relating to the transaction to the purchaser of protection and to the provider of protection, the plurality of workstations including:
one workstation that is adapted to receive a command to enter into the transaction by paying a risk protection premium to the provider of protection in exchange for a right to receive payment in the event that the value of the distressed instrument on or about the maturity date is below a strike price, the value of the distressed instrument on or about the maturity date being at least based on the value of assets pledged to secure the distressed instrument, the strike price being at least based on the value of the distressed instrument as of the effective date; and
one workstation that is adapted to display the risk protection premium to the provider of protection; and
a server coupled to the workstations that processes the information and commands displayed to and received from the purchaser of protection and the provider of protection.

30. The system of claim 29 wherein the right to receive the payment comprises a right to receive an amount substantially equal to the difference between the strike price and the value of the distressed instrument on or about the maturity date.

31. The system of claim 29 wherein the right to receive the payment comprises a right to receive an amount substantially equal to the strike price in return for delivering the distressed instrument.

32. The system of claim 29 wherein the server determines the value of the distressed instrument on or about the maturity date as the greater of (i) a secondary market trading value of the distressed instrument, and (ii) the value of the assets pledged to secure the distressed instrument.

33. The system of claim 32 wherein the server determines the secondary market trading value based on an arithmetic average of bid prices relating to the distressed instrument, the bid prices being provided within a specified period of time after the maturity date.

34. The system of claim 29 wherein the server determines the value of the assets pledged to secure the distressed instrument through an appraisal process.

35. The system of claim 29 wherein the server determines the value of the assets pledged to secure the distressed instrument as an amount recovered from selling the assets.

36. The system of claim 29 wherein the server determines the value of the distressed instrument on or about the maturity date through a sale of the assets pledged to secure the distressed instrument.

37. The system of claim 29 wherein the server determines the value of the distressed instrument on or about the maturity date within a specified period of time after the maturity date.

38. The system of claim 29 wherein the server determines the risk protection premium based on the sum of (i) a credit risk associated with the purchaser of protection, and (ii) an additional risk premium based on the assets pledged to secure the distressed instrument.

39. The system of claim 29 wherein the transaction may be terminated prior to the maturity date in the event of a credit event of default.

40. The system of claim 29 wherein the transaction may be terminated voluntarily through one of the plurality of workstations prior to the maturity date.

41. The system of claim 29 wherein the server processes trades in connection with the distressed instrument.

42. The system of claim 41 further comprising a clearing center coupled to the server, the clearing center for causing the transaction and trades to be completed and cleared and for verifying that the transaction and trades are completed and cleared.

43. An apparatus for hedging against risk associated with a distressed instrument having a maturity date through a transaction entered into by a purchaser of protection and a provider of protection on an effective date, the apparatus comprising:
a server comprising:
a server storage device;
a server processor connected to the server storage device, the server storage device storing a server program for controlling the server processor; and
the server processor operative with the server program to process the transaction, the transaction comprising payment of a risk protection premium to the provider of protection in exchange for the purchaser of protection's right to receive payment in the event that the value of the distressed instrument on or about the maturity date is below a strike price, the value of the distressed instrument on or about the maturity date being at least based on the value of assets pledged to secure the distressed instrument, the strike price being at least based on the value of the distressed instrument as of the effective date; and
a plurality of workstations, each of the plurality of workstations operative to communicate with the server, each of the workstations comprising:
a workstation storage device;
a workstation processor connected to the workstation storage device, the workstation storage device storing a workstation program for controlling the workstation processor; and
the workstation processor operative with the workstation program to:
display information relating to the transaction to the purchaser of protection and to the provider of protection; and
receive a command to enter into the transaction.

44. The apparatus of claim 43 wherein the right to receive the payment comprises a right to receive an amount substantially equal to the difference between the strike price and the value of the distressed instrument on or about the maturity date.

45. The apparatus of claim 43 wherein the right to receive the payment comprises a right to receive an amount substantially equal to the strike price in return for delivering the distressed instrument.

46. The apparatus of claim 43 wherein the server processor determines the value of the distressed instrument on or about the maturity date as the greater of (i) a secondary market trading value of the distressed instrument, and (ii) the value of the assets pledged to secure the distressed instrument.

47. The apparatus of claim 46 wherein the server processor determines the secondary market trading value based on an arithmetic average of bid prices relating to the distressed instrument, the bid prices being provided within a specified period of time after the maturity date.

48. The apparatus of claim 43 wherein the server processor determines the value of the assets pledged to secure the distressed instrument through an appraisal process.

49. The apparatus of claim 43 wherein the server processor determines the value of the assets pledged to secure the distressed instrument as an amount recovered from selling the assets.

50. The apparatus of claim 43 wherein the server processor determines the value of the distressed instrument on or about the maturity date through a sale of the assets pledged to secure the distressed instrument.

51. The apparatus of claim 43 wherein the server processor determines the value of the distressed instrument on or about the maturity date within a specified period of time after the maturity date.

52. The apparatus of claim 43 wherein the server processor determines the risk protection premium based on the sum of (i) a credit risk associated with the purchaser of protection, and (ii) an additional risk premium based on the assets pledged to secure the distressed instrument.

53. The apparatus of claim 43 wherein the transaction may be terminated prior to the maturity date in the event of a credit event of default.

54. The apparatus of claim 43 wherein the transaction may be terminated voluntarily through one of the plurality of workstations prior to the maturity date.

55. The apparatus of claim 43 wherein the server processor processes trades in connection with the distressed instrument.

56. The apparatus of claim 55 further comprising a clearing center operative to communicate with the server, the clearing center comprising:
a clearing center storage device;
a clearing center processor connected to the clearing center storage device, the clearing center storage device storing a clearing center program for controlling the clearing center processor; and
the clearing center processor operative with the clearing center program to cause the transaction and trades to be completed and cleared and to verify that the transaction and trades are completed and cleared.
